(19) United States
(12) Patent Application Publication
(10) Pub. No.: US 2004/0048050 A1
(43) Pub. Date: Mar. 11, 2004

(54) Method for making a circuitry comprising conductive tracks, chips and micro-vias and use of same for producing printed circuits and multilayer modules with high density of integration

(76) Inventors: Robert Cassat, Ternay (FR); Vincent Lorentz, Bergholtz (FR)

Correspondence Address: BURNS DOANE SWECKER & MATHIS L L P, POST OFFICE BOX 1404, ALEXANDRIA, VA, 22313-1404, US

(21) Appl. No.: 10/343,020

(22) PCT Filed: Jul. 26, 2001
(86) PCT No.: PCT/FR01/02465

(30) Foreign Application Priority Data
Jul. 27, 2000 (FR) 00/09879

(51) Int. Cl. B32B 3/00

(52) U.S. Cl. 428/209

(57) ABSTRACT

The invention concerns a method for making a circuitry comprising conductive tracks, chips and micro-vias, at the top surface of a dielectric (303) consisting of a polymer matrix, a compound capable of inducing subsequent metallization and, if required one or several non-conductive and inert fillers, said dielectric (303) covering a level of circuitry (302) or metallized layer, which comprises steps which consist in: a) perforating right through said dielectric (303) without perforating the subjacent metallized layer or the subjacent level of circuitry (302), so as to form one or several micro-vias (304) at desired sites; b) forming, by metallization, metal tracks (312), chips (313) and micro-vias (311) at the surface of the dielectric (314) and of the micro-vias (304), while providing selective protection by depositing a protective layer.

The invention relates to an improved process for producing an interconnect circuitry having a high integration density and comprising conducting tracks, pads and microvias.

Within the context of the invention, the term “microvias” is understood to mean microconnections passing right through the thickness of a dielectric layer.

Within the electronics field, there is a trend towards optimum product miniaturization and towards increasing performance in terms of speed. These trends are accentuated by the growing use of surface-mounted components such as BGA/CGA, CSP or other flip-chip components.

Integration densification is desirable in three dimensions: both in an axial direction by successively stacking ever thinner dielectric/copper layers, in order to obtain a multilayer, and in the plane perpendicular to this direction by bringing ever finer tracks and pads closer together.

The process of the invention meets these requirements by producing a “fine line” circuitry characterized by track and intertrack widths of less than 100 m and hole or via diameters of less than 100 m.

Moreover, this process ensures excellent adhesion of the metal layers to the dielectric substrate and limits the underetching phenomena, that is to say it prevents non-uniform etching at the microvias.

This process of the invention is furthermore economically advantageous in so far as it simplifies the overall procedure for metallizing the vias, pads and tracks by reducing the number of steps.

According to a first of its aspects, the invention provides a process for forming and for metallizing blind holes or microvias in a dielectric covering a first circuitry level or a first metallized layer, without any damage to the said first circuitry level or to the said first metallized layer.

A convention process in the prior art consists in carrying out the succession of the following various steps:

etching and possibly oxidizing a metallized layer supported by a dielectric (RCC arrangement);

cutting one or more microvias in the dielectric at the places where the metal layer has been etched and oxidized;

carrying out a surface treatment by oxidizing acid pickling (or stripping) in order to promote the subsequent bonding of metal particles;

sensitizing and activating the resulting surface, the sensitization generally being carried out by immersion in an acid solution of a stannous salt; and the activation possibly being carried out by dipping in an aqueous solution of a palladium salt;

electrolessly metallizing the resulting activated surface, the microvias also being metallized during this operation;

possibly reinforcing the metal layer obtained by subsequent electrolytic metallization;

drying and brushing the resulting surface;

coating the part forming the interconnect circuitry with a protective layer; then

etching the unprotected metal.

EP 82 094 also describes a simplified process for metallizing plastic substrates in which an electrically insulating substrate is firstly formed by combining a polymer resin with copper oxide particles, then at least some of the cuprous oxide present in the said resin is reduced to metallic copper, and then the desired metal layer is deposited, the said process being especially characterized in that the reduction to metallic copper is carried out by the action of a borohydride and in that it comprises neither an activation step nor a sensitization step.

The fabrication of interconnect circuitries obtained from the metallized element obtained by implementing the process of EP 82094 involves steps similar to those described above, especially for the purpose of forming blind vias.

Surprisingly, the inventors have developed a process allowing interconnects (tracks, pads and microvias) to be rapidly formed on the surface of a dielectric for the purpose of producing integrated circuits, printed circuits and multilayer modules having a high integration density. This process, apart from its ease of implementation, has the advantages of solidly anchoring the copper to the surface of the dielectric and of optimally miniaturizing the microvias.

More specifically, the process of the invention makes it possible to produce an interconnect circuitry comprising conducting tracks, pads and microvias, on the upper surface of a dielectric consisting of a polymer matrix, of a compound capable of inducing subsequent metallization and, where appropriate, of one or more other, non-conducting and inert, fillers, the said dielectric covering a circuitry level or a metallized layer, by implementing the steps consisting in:

A) drilling right through the said dielectric without drilling the subjacent metallized layer or the subjacent circuitry level so as to form one or more microvias at the desired locations;

B) forming, by metallization, metal tracks, pads and microvias on the surface of the dielectric and of the microvias with the use of selective protection by deposition of a protective layer.

The circuitries are obtained by stacking and drilling layers and/or deposits of materials of various types on defined parts. Thus, metal tracks, pads and microvias are formed which are separated in places and supported by layers of dielectric.

The tracks, pads and microvias form an interconnect circuitry.

The tracks are circuitry parts positioned on the surface of a dielectric. They are generally in the form of thin lines.

The circuitries according to the invention may comprise several circuitry levels.

Each circuitry level corresponds to a number of tracks on the surface of a dielectric. The circuitry levels are therefore separated by a layer of dielectric, with, in places, metal connections between the levels. These metal connections between two or more levels are called microvias. The pads correspond to a widening of a metal deposit in the regions where the microvias open out. Such structures are known to those skilled in the art.

According to the invention, the tracks, pads and microvias are formed on the upper surface of a dielectric which contains a compound capable of inducing subsequent metallization. The dielectric covers a circuitry level (a lower circuitry level) or a metallized layer.

The dielectric may be placed on the circuitry level or on the metallized layer in liquid form, undergoing subsequent solidification. It may also be applied in the form of a solid laminated product. In the latter case, it is possible to use a two-layer laminated product comprising on one side a layer of the said dielectric containing the compound capable of inducing subsequent metallization and on the other side a metal layer (RCC). The two-layer laminated product is applied to the circuitry level or to the metallized layer so that the side containing the compound capable of inducing subsequent metallization covers the circuitry level or the metallized layer, and the metal layer is removed from the laminated product, for example by etching. Thus, a dielectric surface is obtained which makes the peel force of the metal deposits (tracks and pads) which will be formed thereon particularly high. This technique is often called “full etching”.

The circuitry level covered by the dielectric may itself be produced by a process according to the invention. It may also be produced according to another process. For example, it may be a printed circuit comprising one or more levels on a rigid or flexible support, possibly with conducting vias. As regards the support, this may, for example, be an injection-moulded insulating material or a composite material conventional in the field of printed circuits. Mention may be made, for example, of supports based on epoxy/glass fibres. It may be a dielectric which includes a web of non-woven fibres or a paper impregnated with dielectric resin. The presence of the web of fibres or of the paper ensures good uniformity of the thermal expansion coefficients (TECs).

Particularly advantageously, the support is a web consisting of non-woven aramid (a commercial aromatic polyamide) fibres preimpregnated with an epoxy resin, with a polyimide resin or with a blend of these resins. Better still, these aramid fibres (which are preferably meta-aramid fibres, para-aramid fibres or a mixture of such fibres) are preimpregnated with a functionalized polyamideimide resin (functionalized with heat-crosslinkable chemical units). This functionalization may be achieved with double bonds or with maleimide groups such as those defined in patent EP 0 336 856 or U.S. Pat. No. 4,927,900. Advantageously, the web comprises 35 to 60% by weight, preferably from 44 to 55% by weight and better still from 40 to 50% by weight, for example 47% by weight, of dielectric resin.

By way of example, the thickness of the web varies between 10 and 70 μm, preferably between 15 and 50 μm and better still between 20 and 40 μm.

In general, its grammage varies between 10 and 50 g/m² and better still between 15 and 40 g/m².

It should be pointed out that the circuitries obtained by the process according to the invention may be produced on one or both sides.

During step A), the dielectric is drilled right through so as to form one or more microvias at the desired locations, without drilling the subjacent circuitry level or the subjacent metallized layer. The microvias are subsequently metallized so as to make connections through the dielectric.

The drilling may be carried out conventionally, by plasma or laser, the latter technique being much preferred in so far as it results in substantially smaller microvia diameters and allowing markedly higher drilling rates.

Among the lasers that can be used, mention may be made of YAG lasers, CO₂ lasers, combined YAG/CO₂ lasers and excimer lasers. A person skilled in the art will easily know how to select the appropriate laser depending on the dielectric to be drilled. Very special attention has to be paid to the final drilling step, given that the subjacent metallized layer or the subjacent circuitry level must remain intact.

A CO₂ laser operating at wavelengths of 9300 nm to 10600 nm is particularly preferred for implementing step a) in so far as it allows the dielectric to be selectively drilled without touching the subjacent metal layer and without any additional adjustment being necessary, the metal layer not being attacked by the CO₂ laser. The drilling speed of the CO₂ laser, which is greater than that of a YAG laser, also makes this drilling technique particularly advantageous.

A YAG laser is in this case more difficult to use since it may drill the subjacent metallized layer and may require precise control of the drilling operation in its final phase.

Preferably, the microvia diameter is greater than the thickness of the dielectric.

During step B), metal tracks, pads and microvias are formed, by metallization, on the surface of the dielectric and of the microvias. To do this, selective protection is employed, by deposition of a protective layer. The processes for forming metal interconnects with selective protection, particularly by means of a photosensitive resin, are known to those skilled in the art. In particular, mention may be made of the pattern-type processes and the panel-type processes. In the case of the process according to the invention, metallization of the dielectric is made possible owing to the compound capable of inducing subsequent metallization, and possibly to a suitable treatment prior to the metallization, for example a treatment resulting in the formation of a sublayer capable of being metallized. Methods of forming such a sublayer will be explained in detail later.

Step B) may itself comprise several steps. Several methods of implementation corresponding to sequences of different steps will be explained in detail.

With regard to the compound capable of inducing subsequent metallization, this is preferably in the form of particles of a metal oxide chosen from Cu, Co, Cr, Cd, Ni, Pb, Sb and Sn oxides and mixtures thereof. Particles of cuprous oxide Cu₂O are most particularly preferred. With regard to the metal oxide used, this must be in the form of small-sized particles; the particle size is generally between 0.1 and 5 μm. The presence of metal oxide particles in the dielectric decreases the thermal expansion coefficient isotropically, while at the same time favouring heat transfer.

The compound capable of inducing subsequent metallization may also be an organometallic compound.

With regard to the polymer matrix, this is a dielectric, that is to say it is electrically insulating. The nature of this material is not critical according to the invention.

Preferably, it is a thermoplastic polymer, a thermosetting resin or a blend of such constituents.

As examples of thermoplastic polymers, mention may be made of polymers of the type comprising polyolefins, polyvinyls, polystyrenes, polyamides and polyamideimides, acrylics, polysulphones, polysulphides, polyphenylene oxides, polyacetals, fluoro polymers, parabanic polymers, polyhydantoins, linear polyimides, polyalkylene oxides, linear polyurethanes, saturated polyesters, elastomers or a blend of these polymers.

Suitable thermosetting resins are of the type comprising phenolic prepolymers, unsaturated polyesters, epoxides, bismaleimide-type polyimides, reactive polyamideimides, triazines, cyanate esters or a blend of these resins.

Examples of polyolefin resins are polyethylene, polypropylene and ethylene-propylene copolymers.

Vinyl resins are polyvinyl chloride, polyvinylidene chloride and ethylene-vinyl acetate copolymers.

Polystyrene resins are illustrated by polystyrene, styrene-butadiene copolymers, styrene-acrylonitrile copolymers and styrene-butadiene-acrylonitrile copolymers.

As polyamide polymers, mention may be made of polyhexamethyleneadipamide (nylon-6,6) polyaminocaprolactam (nylon-6) and polyundecanamide (nylon-11).

Suitable acrylic polymers that can be used are, for example, polymethyl methacrylate, linear polyurethanes and especially polyurethanes resulting from the polymerization of hexamethylene diisocyanate with 1,3-propanediol or 1,4-butanediol.

Saturated polyesters are, for example, polyethylene glycol terephthalate or polybutylene glycol terephthalate, fluorinated polyesters, polycarbonates, polyacetals, polyphenylene oxides, polyphenylene sulphides or thermoplastic elastomers.

The phenolic resins are, for example, the condensates of phenol, resorcinol, cresol or xylenol with formaldehyde or furfural.

Unsaturated polyesters are products of the reaction of an unsaturated dicarboxylic acid anhydride, such as maleic or citraconic anhydride, with a polyalkylene glycol.

As examples of epoxide resins, mention may be made of the products from the reaction of 1-chloro-2,3-epoxypropane or 1,2,3,4-diepoxybutane with bisphenol A or with other phenols, such as resorcinol, hydroquinone or 1,5-dihydroxynaphthalene.

As elastomers, mention may be made of natural or synthetic rubbers, silicones or polyurethanes.

As suitable fluoro polymers, mention may be made of polytetrafluoroethylene and polyvinylidene fluoride.

Preferably, the polymer matrix is a thermosetting resin of the polyimide or epoxide type or else a thermoplastic polymer of the polyamideimide type.

The polymer matrix forming the dielectric may contain one or more other electrically insulating fillers, which are completely inert under the operating conditions of the process of the invention. They act as reinforcing fillers and are, for example, formed from simple fibres, of mineral or organic nature, the length of which does not in general exceed 10 mm, especially such as asbestos fibres or ceramic fibres, or preferably glass fibres, or else they are reinforcing materials of great length: yarns, wovens, nonwovens or knits.

Other reinforcing fillers consist of particles of mineral or organic nature, such as mica, molybdenum sulphide, alumina, silica and polytetrafluoroethylene particles, or glass microspheres. The particle size of the fillers is chosen so as to be compatible with the application by deposition of the polymer matrix.

The dielectric may also contain calcium carbonate particles. These particles are capable of creating roughness on the surface of the dielectric by being dissolved by acid etching.

Preferably, the thickness of the dielectric does not exceed 100 μm. Advantageously, the dielectric layer has a thickness of between 10 and 70 μm, better still between 15 and 50 μm, for example between 20 and 40 μm.

According to one particularly preferred method of implementation, the dielectric includes, as inert non-conducting filler, a nonwoven fibrous web or a paper, impregnated with dielectric resin. The presence of the said web ensures better uniformity of the thermal expansion coefficients (TECs), without impairing the ability of the dielectric to be laser-ablated.

Incorporating such a filler into the dielectric also makes it possible to reduce the thickness of the dielectric layer and therefore to further improve the miniaturization.

According to a first method of implementation, the said filler is a paper as described in FR 2 685 363 or U.S. Pat. No. 5,431.782.

Particularly advantageously, the filler is a web consisting of nonwoven aramid fibres (commercial aromatic polyamide fibres) preimpregnated with an epoxy resin, a polyimide resin or a blend of these resins. Better still, these aramid fibres (which are preferably meta-aramid fibres, para-aramid fibres or a mixture of such fibres) are preimpregnated with a functionalized polyamideimide resin (functionalized with heat-crosslinkable chemical units). This functionalization may be obtained with double bonds or maleimide groups as defined in patent EP 0 336 856 or U.S. Pat. No. 4,927,900. Advantageously, the web contains 35 to 60% by weight, preferably from 44 to 55% by weight and better still from 40 to 50% by weight, for example 47% by weight, of dielectric resin.

For example, the thickness of the web varies between 10 and 70 μm, preferably between 15 and 50 μm and better still between 20 and 40 μm.

In general, its grammage varies between 10 and 50 g/m², better still between 15 and 40 g/m².

The tracks, pads and microvias are formed by metallization in step B) over all or part of non-protected surfaces of the dielectric, either before the protective layer has been applied or after certain parts of the latter have been removed. The metallization may be carried out electrochemically (electrolessly) and/or electrolytically (with a current). The latter process is more particularly preferred as it is more rapid. In addition, it may be carried out in acid medium, thereby preventing the photosensitive layers from swelling and thus improving the positioning precision for the various irradiation and development steps and improving the reliability and longevity of the circuitries. For electrolytic metallization it is advantageous to operate with increasing current. The metal is preferably copper.

Electrochemical (electroless) metallization is a known technique, which is described in “Encyclopedia of Polymer Science and Technology, 1968, Vol. 8, 658-61”.

Likewise, the electrolytic metallization, (with a current) is a conventional technique also described in “Encyclopedia of Polymer Science and Technology, 1968, Vol. 8, pp. 661-63”.

According to a particularly preferred method of implementing the invention, the metallization, whether electrochemical or electrolytic, is continued until a metal layer having a thickness of at least 5 μm, preferably a thickness of between 10 and 20 μm, is obtained.

Step B) comprises, advantageously before the metallization, a step of forming a sublayer capable of being metallized. Such a sublayer is formed on the entire surface of the dielectric, or on exposed parts of the dielectric with selective protection of the other parts. Depending on the case, the sublayers formed are continuous or discontinuous and may or may not be directly suitable for electrolytic metallization. On the other hand, they are always suitable for electrochemical metallization. In this case, the electrochemical deposition of metal is catalysed by the sublayer, and the metallization is equivalent to that using palladium or platinum.

Two methods of production for obtaining a sublayer capable of being metallized are preferred.

According to a first method of producing the sublayer, the compound capable of inducing subsequent metallization is chosen from the abovementioned metal oxides and the sublayer is formed by bringing the dielectric or exposed parts of the dielectric into contact with a solution of a salt of a noble metal capable of being reduced by oxide particles.

During this step, other layers may be brought into contact with the solution. The latter has no useful action on these other layers. Thus, a continuous sublayer of the noble metal is formed on the exposed surface of the first layer. The surface resistivity of the sublayer is between 10⁶ and 10³ Ω/. It is preferably less than 10³ Ω/. This allows electrochemical metallization to be carried out, preferably with increasing current. It should be pointed out by way of indication that the cohesion of the sublayer improves as the concentration of oxide particles increases.

As preferred solutions of noble metal salts, mention may be made of Au, Ag, Rh, Pd, Cs, Ir and Pt salt solutions with a counterion chosen from Cl³¹ , NO₃⁻ and CH₃COO⁻. The contacting process may be carried out by dipping into the solution, by spraying or by the passage of a roller. The solution of noble metal salt is in general acidic, with a pH of between 0.5 and 3.5, preferably between 1.5 and 2.5. The pH may be controlled by adding acid. This treatment in acid medium furthermore makes it possible to limit the swelling of the resin layers, which takes place in basic medium. Excellent definition and excellent planarity are therefore obtained using this first method of producing the circuitries. It should be mentioned that the treatment with an acid solution of noble metal salts may be preceded by rinsing with an acid solution, for example with acetic acid, if the first layer of photosensitive resin contains calcium carbonate particles. This rinsing makes it possible to increase the roughness of the surface, the calcium carbonate particles present on the surface being dissolved, and thus to improve the adhesion of the metal deposits.

For the first method of forming a sublayer, the metal oxide particles are preferably chosen from MnO, NiO, Cu₂O and SnO and are preferably contained in the first layer in an amount of 2.5-90% by weight, even more preferably in an amount of 10 to 30%. The preferred metal oxide is cuprous oxide Cu₂O. Advantageously, the solution contains at least 10−5 mol/l, preferably between 0.0005 and 0.005 mol/l, of noble metal salt. A continuous sublayer of noble metal having a thickness of less than 1 μm is obtained. The sublayer obtained exhibits excellent uniformity, thereby improving the quality of the connections obtained after metallization. By way of salts that can be used, mention may be made of AuBr₃ (HAuBr₄), AuCl₃ (HAuCl₄) or Au₂Cl₆, silver acetate, silver benzoate, AgBrO₃, AgClO₄, AgOCN, AgNO₃, Ag₂SO₄, RuCl₄.5H₂O, RhCl₃.H₂O, Rh(NO₃)2.2H₂O, Rh₂(SO₄)₃.4H₂O, Pd(CH₃COO)₂, Rh₂(SO₄)₃.12H₂O, Rh₂(SO₄)₃.15H₂O, PdCl₂, PdCl₂.2H₂O, PdSO₄, PdSO₄.2H₂O, Pd(CH₃COO)₂, OsCl₄, OsCl₃, OsCl₃.3H₂O, OSI₄, IrBr₃.4H₂O, IrCl₂, IrCl₄, IrO₂, PtBr₄, H₂PtCl₆.6H₂O, PtCl₄, PtCl₃, Pt(SO₄)₂.4H₂O and Pt(COCl₂)Cl₂, and corresponding complexes such as NaAuCl₄, (NH₄)₂PdCl₄ (NH₄)₂PdCl₆, K₂PdCl₆ and KAuCl₄.

The sublayer obtained is particularly well-suited to electrolytic metallization. For example, electrolytic metallization with an increasing current may be used.

The formation of the sublayer within the context of the first method may especially comprise the following operations:

exposure of the metal oxide particles contained in the first layer of photosensitive resin. This operation is preferably carried out by alkaline etching (for example using a sodium hydroxide or potassium hydroxide solution in aqueous/alcoholic medium) and then rinsing with water, possibly in an ultrasonic bath, so as to remove the oxide particles exposed;

if the dielectric contains inert fillers, such as calcium carbonate fillers, the surface is made slightly rough by acid etching. This operation is preferably separate from the operation of forming the metal sublayer;

forming a continuous metal sublayer of noble metal by contacting with an aqueous, acid solution of a noble metal salt. By way of indication, it should be mentioned that the sublayer obtained is generally a monoatomic layer since the noble metal acts as a barrier to continuation of the oxidation-reduction reaction. The layer is continuous as some of the metal oxide particles release ions by dissolution. These ions react in aqueous medium with the noble metal salt, reducing this metal, which is deposited, thus filling the inter-particle spaces. The reaction is all the more effective and economic the more confined the aqueous noble metal salt medium. For this reason, it is preferred to carry out the reaction in a thin layer, that is to say by immersion in the solution containing the noble metal salt, and to remove it as soon as possible afterwards. The reaction then takes place in the aqueous solution layer entrained with the object.

According to a second method of producing the sublayer, the compound capable of inducing subsequent metallization consists of particles of a metal oxide chosen from Cu, Co, Cr, Cd, Ni, Pb and Sb oxides and mixtures thereof, the sublayer being obtained by subjecting all or part of the dielectric to the reducing action of a suitable reducing agent so as to obtain a metal sublayer covering in particular the microvias, by reduction of the metal oxide particles on the exposed surface of the dielectric, the surface resistivity of which is between 0.01 and 101 Ω/.

For this method of implementation, the proportions of the constituents of the dielectric according to the present invention are preferably chosen to be between the following limits (expressing the percentage by weight of each of the constituents in the substrate):

10 to 90%, preferably 25 to 90%, of metal oxide, preferably cuprous oxide;

from 0 to 50% of one or more other fillers inert under the reduction conditions; and

from 10 to 90%, preferably from 10 to 75%, of polymer resin.

As a variant, the dielectric consists of:

less than 10% by weight of metal oxide, preferably cuprous oxide;

0 to 50% by weight of inert non-conducting filler(s); and

from 10 to 90%, preferably from 10 to 75%, by weight of polymer resin.

The surface resistivity that it is preferable to achieve for the sublayer according to the second method of implementation depends on the nature of the dielectric.

When the dielectric consists of 10 to 90% by weight of metal oxide, 0 to 50% by weight of inert non-conducting filler(s) and 10 to 90% by weight of polymer resin, the reduction is advantageously continued until a surface resistivity of 0.01 to 103 Ω/is obtained. Preferably, the metallizations are produced in this case electrolytically, for example with increasing current.

When the dielectric consists of less than 10% by weight of metal oxide, 0 to 50% by weight of inert non-conducting filler(s) and 10 to 90% by weight of polymer resin, the reduction is advantageously continued until a surface resistivity of greater than 10⁶ Ω/is obtained. The metallizations are preferably produced in this case electrochemically.

The presence of the said continuous or discontinuous metal sublayer also ensures catalysis of the subsequent metal deposit produced, while being completely compatible therewith.

More specifically, this sublayer, whether obtained according to the first method or the second method, helps to improve the adhesion of the subsequent metal deposit by preventing any break in the electrical conduction at the metallized vias.

Before carrying out the reduction step in order to form the sublayer, it may prove necessary beforehand to strip the surface of the dielectric so as to expose the metal oxide particles on the surface. This is especially the case when all the metal oxide particles are covered with the polymer matrix. The stripping treatment consists either of a chemical treatment using a chemical capable of etching the surface of the polymer matrix, or of a stripping technique using mechanical means, such as abrasion, brushing, sandblasting, milling or filing.

According to a preferred method of implementing the invention, the stripping is carried out using mechanical means.

During the operation of forming the sublayer according to the second method, when the metal oxide is a cuprous oxide, some of the copper is reduced to the CuH state, in which state the copper acts as a catalyst for the metal deposition carried out at B). If there is an excess amount of CuH, it is slowly converted to copper metal at room temperature, with hydrogen diffusing to the outside.

Hereafter, the presence of this transient hydride will no longer be mentioned and reference will simply be made to a metal layer.

In order to carry out the reduction, a person skilled in the art may select any one of the reducing agents capable of reducing metal oxide to metal oxidation state 0.

Obtaining the desired resistivity values during this step will depend, on the one hand, on the proportions and on the nature of the metal oxide within the polymer matrix forming the dielectric and, on the other hand, on the extent of the reduction performed, and especially on the type of reducing agent used, and on the prior stripping step.

The nature of the metal layer deposited varies depending on the type of reducing agent used and on the nature of the metal oxide to be reduced.

According to a preferred method of implementing the invention, the reducing agent is a borohydride.

Hereafter, the action of borohydrides is described more specifically when the metal oxide is a cuprous oxide.

Cu₂O is reduced to metallic copper by the action of a borohydride.

By using this type of reducing agent, the layer formed on the surface of the dielectric is a continuous or discontinuous metal layer of copper.

The borohydrides that can be used in the present invention include substituted borohydrides as well as unsubstituted borohydrides. Substituted borohydrides in which at most three hydrogen atoms of the borohydride ion have been replaced with substituents which are inert under the reduction conditions, such as for example with alkyl radicals, aryl radicals and alkoxy radicals, may be used. Preferably, alkaline borohydrides are used in which the alkaline part consists of sodium or potassium. Typical examples of compounds that are suitable are: sodium borohydride, potassium borohydride, sodium diethylborohydride and potassium triphenylborohydride.

The reducing treatment is carried out simply by bringing the dielectric surface into contact with a solution of the borohydride in water or in a mixture of water and of an inert polar solvent such as, for example, an aliphatic lower alcohol.

Preference is given to purely borohydride solutions. The concentration of these solutions may vary over wide limits and it preferably lies between 0.05 and 1% (by weight of active hydrogen of the borohydride in the solution). The reducing treatment may be carried out at high temperature; however, it is preferred to do so at a temperature close to room temperature, for example between 15 and 30° C. With regard to the execution of the reaction, it should be noted that it gives rise to B(OH)₃ and to OH⁻ions, which have the effect of increasing the pH of the medium during the reduction. However, at high pH values, for example greater than 13, the rate of reduction is decreased so that it may be advantageous to operate in a buffered medium so as to have a well-defined reduction rate.

By varying mainly the treatment time, it is possible to easily control the extent of the reduction performed. To obtain a surface resistivity corresponding to the desired values, the treatment time necessary is generally quite short and, depending on the amounts of oxide included in the dielectric, is usually between about one minute and about fifteen minutes. For a given treatment time, it is possible to further vary the reduction rate by adding various accelerators to the medium, such as for example boric acid, oxalic acid, citric acid, tartaric acid or metal chlorides such as cobalt(II) chloride, nickel(II) chloride, manganese(II) chloride and copper(II) chloride.

It is also possible to vary the amount of borohydride used so as to control the extent of the reduction. A preferred operating method consists in dipping the substrate to be reduced into a relatively viscous borohydride solution and then in withdrawing the substrate in order to allow the reduction operation to take place in air. The amount of borohydride ions BH4— consumed depends on the viscosity. The BH₄⁻therefore reacts in a thin layer on the surface to be reduced. This process also has the advantage of neither contaminating the initial bath nor of destabilizing it.

The exact and precise conditions of the reduction by the borohydride are such as those described in EP 82 094. However, it must be understood that, within the context of the invention, only a surface part of the dielectric has to be reduced.

As a variant, if by reduction of the copper oxide particles a continuous metallic layer of copper was firstly deposited on the surface of the dielectric, it is possible for there to be an inter-exchange of metals so as to convert the copper layer into a layer of a metal other than copper, by oxidation-reduction. In general, the process involves bringing the coppered layer into contact with a suitable metal salt, in acid medium, the condition being that the oxidation potential of the Cu₂O/Cu redox pair be less than that of the redox pair for the metal to be deposited.

Another possible method of implementation for the sublayer capable of being metallized may be used. According to this method of implementation, the compound capable of inducing subsequent metallization is an organometallic compound, the sublayer being obtained by subjecting all or part of the dielectric to the action of a laser or a plasma until a metal sublayer covering in particular the microvias is obtained. Before the step of forming the sublayer, this laser or plasma technique may also be used for optionally prestripping the surface of the dielectric so as to expose the particles of organometallic on the surface.

The metallization of the sublayers is carried out as described above.

Three preferred methods of implementation for step B) will now be described. The methods of implementation are illustrated by figures showing schematic cross-sectional views of the circuitries produced by a process according to the invention.

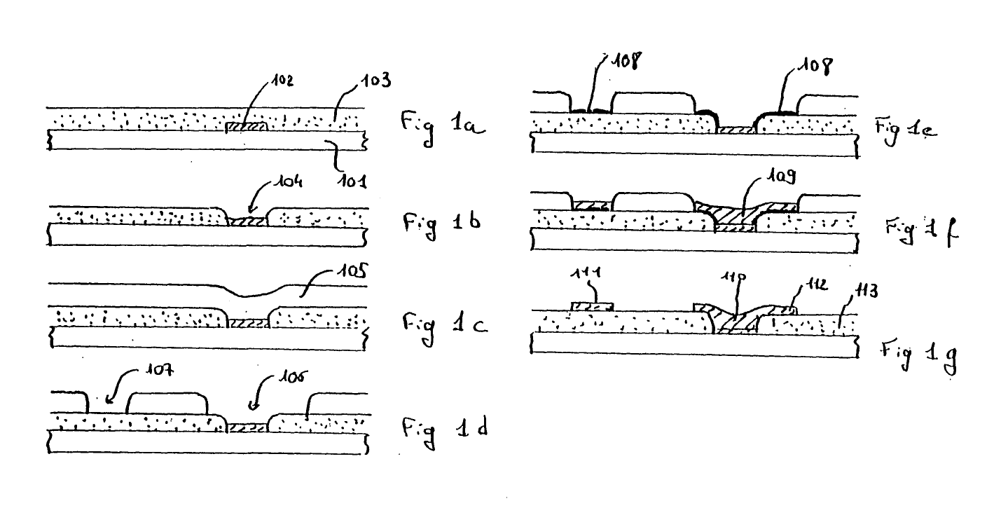

FIGS. 1a) to 1g) show the circuitry at the various steps in the process according to the second method of implementation.

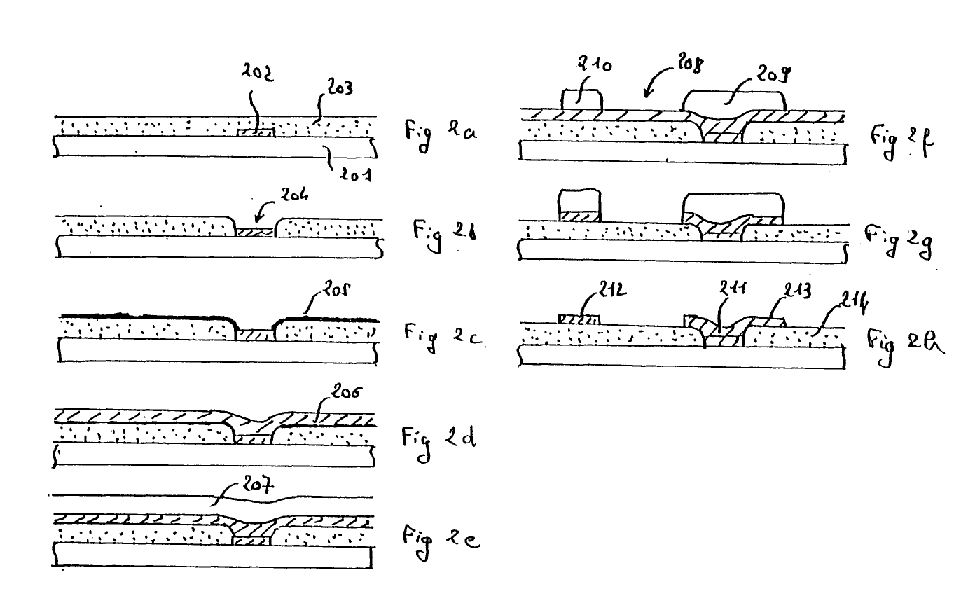

FIGS. 2a) to 2h) show the circuitry at the various steps in the process according to the third method of implementation.

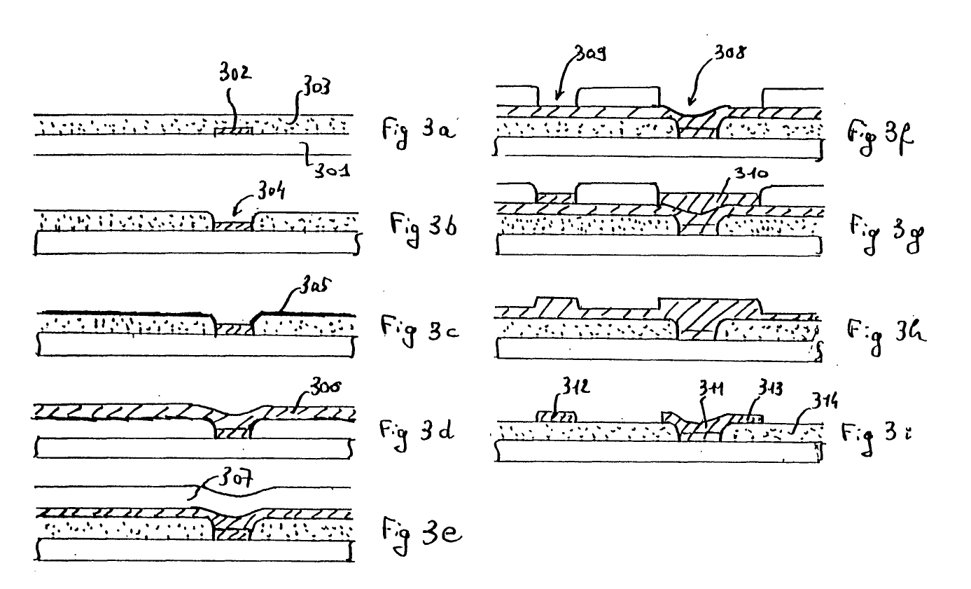

FIGS. 3a) to 3i) show the circuitry at the various steps in the process according to the first method of implementation.

According to a first method of implementation, illustrated in FIGS. 3a) to 3i), in which a support 301, a circuitry level 302 and the dielectric 303 are shown, step B) comprises the steps consisting in:

B1) forming a sublayer 305 capable of being metallized on the surface of the microvias 304, and on the surface of the dielectric or of part of the dielectric, by subjecting all or part of the dielectric to the reducing action of a suitable reducing agent so as to obtain a metal sublayer covering in particular the microvias, by reduction of the metal oxide particles on the exposed surface of the dielectric, the surface resistivity of which is between 0.01 and 10¹⁰ Ω/;

B2) producing a circuitry comprising tracks, pads and microvias by carrying out a sequence of treatment steps comprising, in a suitable order, step (i) of electrochemical (electroless) metallization and/or electrolytic metallization and step (ii) of selective protection by deposition of a protective layer.

Step B1) corresponds to the formation of a sublayer according to the second method of implementation described above. This sublayer may, where appropriate, be reinforced with electrochemical and/or electrolytic metallization in order to obtain a metal layer 306 over all of the dielectric and of the microvias.

Step B2) corresponds to the formation of tracks, pads and microvias by the use of selective protection by deposition of a protective layer. This step generally involves a sequence of operations—(i) metallization and (ii) selective protection by depositing a protective layer on part of the exposed surface of the dielectric. Advantageously, it also includes a step (iii) of etching the sublayer or the metal layers capable of being metallized.

The order of implementing these operations in the sequence depends on the method used.

Conventionally, the process is implemented by selective metallization of the circuitry (so-called “pattern” method) or by metallization of the entire surface (so-called “panel” method).

According to the invention, the method of protection that can be used is not critical. For example, it will be possible to use a process consisting in (i) depositing a layer of photosensitive resin over the entire surface of the dielectric or of the sublayer, (ii) in forming an image on the photosensitive layer by irradiation and then (iii) in removing the dissolvable part of the said layer of photosensitive resin.

Two known techniques in the prior art are perfectly suitable.

The first technique consists in depositing a positive photosensitive resin (positive photoresist) or a negative photosensitive resin (negative photoresist) on the entire surface of the sublayer, which is possibly reinforced with a metal layer, resulting from step B1), then subsequently irradiating the layer of resin deposited, in a manner known per se, and using a predetermined mask, and finally in removing the dissolvable part of the photosensitive resin which, depending on the case, consists of the photosensitive resin irradiated through the mask (positive photoresist) or consists of the unirradiated photosensitive resin (negative photoresist).

The second technique is the so-called LDI (Laser Direct Imaging) technique in which the photosensitive resin is exposed directly.

This technique is advantageous from the economic standpoint since it does not require the use of a mask.

According to this second technique, the photosensitive resin is selectively irradiated, pixel by pixel, by a laser beam scanning the surface of the dielectric coated with photosensitive resin.

The dissolvable parts of the resin are then removed in the same way as in the conventional technique, using positive and negative photoresists. The dissolving operation is often also referred to as development.

In order to use this second technique, two types of laser are appropriate, for example: a laser operating in the infrared (thermal LDI) and a UV laser operating in the 330-370 nm wavelength range (UV-LDI).

More specifically, step B2) may comprise the steps consisting in:

B2a) coating certain parts of the surface of the dielectric resulting from step B1) with a protective layer, the parts 309, 308 that are not covered corresponding to the regions intended to form the desired interconnect circuitry;

B2b) reinforcing the said parts not covered in B2a) with a complementary metal deposit 310 applied electrochemically (electrolessly) and/or electrolytically;

B2c) exposing the upper surface of the dielectric by removing the protective layer deposited in step B2a);

B2d) subjecting the metal deposited on the dielectric to differential etching until complete removal, at those parts of the dielectric which were exposed in step B2c), of the continuous copper sublayer formed in step B1).

Step B2a) allows the regions intended to form the desired interconnect circuitry on the surface of the dielectric to be selectively reinforced by deposition of a thicker layer of conducting metal, generally having a thickness of at least 3 μm.

Selectivity is ensured in this step by protecting the future regions containing no circuitry.

According to one particular process, step B2a) comprises the steps consisting in:

B2aα) depositing a layer 307 of photosensitive resin over the entire surface of the dielectric, after treatment with the reducing agent;

B2aβ) forming an image on the photosensitive layer by irradiation;

B2aχ) removing the dissolvable part of the said layer of photosensitive resin.

In step B2b) the non-covered parts of the protective layer are reinforced by a complementary metal deposit applied electrochemically (electrolessly) and/or electrolytically, the latter method being more particularly preferred.

The metal reinforcing layer is preferably a layer of copper, but it should be understood that the invention is not limited to this particular embodiment.

However, it may be envisaged to deposit a layer of various conducting metals, such as a layer of nickel, gold, tin or a tin-lead alloy. (Electroless) electrochemical metallization is a known technique, which is described in “Encyclopedia of Polymer Science and Technology, 1968, Vol. 8, 658-61”.

Likewise, electrolytic metallization is a conventional technique, also described in “Encyclopedia of Polymer Science and Technology, 1968, Vol. 8, 661-63”.

According to a particularly preferred method of implementing the invention, the metallization, whether electrochemical and/or electrolytic, is continued until a metal layer having a thickness of at least 5 μm, preferably a thickness of between 10 and 20 μm, is obtained.

In step B2c), the protective layer deposited in B2a) is removed in a conventional manner known per se. A person skilled in the art will adapt the exposing method to the type of protective layer used in a manner completely known per se.

Next, in step B2d), the metal deposited on the dielectric is subjected to differential etching until the dielectric 314 in the future regions not containing any circuitry are exposed to the air, these regions being covered, at this stage in the process, with a continuous metal layer having a surface resistivity of 0.01 to 10³ ω/. During this step, the regions intended to form the interconnect circuitry and the future regions containing no circuitry are etched simultaneously. However, the thickness of metal covering the regions intended to form the interconnect circuitry 312 (track), the interconnect circuitry 311 (conducting microvia) and the interconnect circuitry 313 (pad), being greater than that covering the future regions containing no circuitry, it is possible to selectively “strip” the coating parts having a small thickness.

The etching is generally carried out until a final thickness of the metal layer of at least 3 μm is obtained. Advantageously, this thickness is preferably between 5 and 18 μm in the interconnect circuitry regions, the remaining regions being completely devoid of metal.

According to a second method of implementation, illustrated in FIGS. 1a) to 1g), in which a support 101, a circuitry level 102 and the dielectric 103 are shown, step B) comprises the following steps:

b1) forming, on the dielectric 103 and on the microvias 104, a layer 105 of photosensitive resin intended to form the selective protection, this layer not containing a compound capable of inducing subsequent metallization;

c1) irradiating and developing the layer of photosensitive resin so as to selectively expose the microvias (exposed region 106) and certain parts of the dielectric (exposed region 107);

d1) forming a sublayer 108 capable of being metallized

either by coming into contact with a solution of a noble metal salt capable of being reduced by the metal oxide particles,

or by coming into contact with a reducing agent capable of reducing the metal oxide particles;

e1) electrochemical and/or electrolytic metallization so as to deposit a metal layer 109 on the parts exposed during step c1).

The layer of photosensitive resin may be removed during a subsequent step leaving, on the surface of the dielectric 113 through which a conducting microvia 110 passes, lines 111 and pads 112.

According to a third method of implementation, illustrated in FIGS. 2a) to 2h), in which a support 201, a circuitry level 202 and the dielectric 203 are shown, step B) comprises the following steps:

b2) forming a sublayer 205 capable of being metallized on the surface of the dielectric and of the microvias 204:

either by coming into contact with a solution of a noble metal salt capable of being reduced by the metal oxide particles,

or by coming into contact with a reducing agent capable of reducing the metal oxide particles;

c2) electrochemical and/or electrolytic metallization so as to deposit a metal layer 206 on the dielectric and on the microvias;

d2) forming, on the metallized surface, a layer 207 of photosensitive resin intended to form the selective protection;

e2) irradiating and developing the layer of photosensitive resin so as to selectively expose certain parts of the metal layer. A protective resin layer 210, 209 remains on certain parts of the metal layer;

f2) removing the metal layer from the parts 208 exposed during step e2);

g2) removing the layer of photosensitive resin.

The surface obtained has surfaces of the dielectric 214, of the conducting microvias 211 through the dielectric, of the lines 211 and the pads 213.

According to another of its aspects, the invention relates to the use of the process according to the invention for the production of printed circuits and of multilayer modules (usually called MCMs or multichip modules in the art) having a high integration density.

Further details and advantages of the invention will become more clearly apparent in the light of the example given below solely by way of indication and describing the manufacture of a printed circuit.

Preparation 1:

This preparation illustrates the manufacture of a nonwoven web, consisting of aramid fibres, which is impregnated with dielectric resin.

A polyamideimide resin was produced from trimellitic anhydride, diisocyanatotoluene (a mixture of the 2,4 and 2,6 isomers in the ratio 80/20) and terephthalic acid (in the trimellitic anhydride/terephthalic acid molar ratio: 60/40).

The diisocyanatotoluene on the one hand and the trimellitic anhydride plus terephthalic acid combination on the other were in stoichiometric amounts.

This polyamideimide resin was obtained in a polar solvent, namely 1,3-dimethyl-2-imidazolidinone (DMEU). At the end of polycondensation, with a solids content of 21%, its viscosity at 20° C. was 630 poise. The resin/solvent mixture is called collodion.

A nonwoven, consisting on the one hand of non-overdrawn KERMEL polyamideimide fibres and on the other hand of pulp of TWARON aramid fibres in a weight ratio of 50/50 was produced continuously, with a grammage of 55 g/m², by a dry route. This web, highly hot-calendered, was then impregnated with the polyamideimide resin prepared above, using a “size press”.

On leaving the “size press”, the impregnated web was immersed in a coagulation bath consisting of a DMEU/water mixture in a weight ratio of 60/40, maintained at 20° C. The web thus impregnated was calendered and then dried, in a countercurrent, by a succession of spray nozzles supplied at the downstream end of the washing system with pure water, which gradually became charged with DMEU in its movement towards the upstream. Some of the washing liquid was used to automatically reequilibrate the composition of the coagulation bath.

After washing, the impregnated web was continuously dried in a fan oven at a temperature of 140° C.

After drying, this web had an overall grammage of 93 g/m². The irregular edges were cut off to give a web 92 cm in width.

Preparation 2:

This preparation illustrates the manufacture of a Cu₂O-filled dielectric comprising an internal layer consisting of a nonwoven web of aramid fibres, the surface stripping of this dielectric, the reduction of the Cu₂O to metallic copper and the copperplating of the resulting dielectric, on both its sides.

Some of the collodion prepared in Preparation 1 was taken and mixed with pulverulent cuprous oxide.

The Cu₂O/polyamideimide collodion weight ratio was 14.6%. This mixture was passed through a so-called “three-roll” machine normally used for preparing paints. The recovery doctor blade of the last roll delivered a Cu₂O suspension into the resin, this suspension being completely homogeneous, and was used to coat the web impregnated in Preparation 1.

The coating was carried out in “full bath” mode and the transfer of filled resin was regulated by a set of two rotating rolls fitted with doctor blades.

The composition of the coating resin was kept constant by a pump which circulated it in a closed loop.

As the coated web moved upwards it passed through an electrical drying oven before coming into contact with the cooled return roll, which returned the web to the winding station.

Measurement of the thickness of the coated web, determined using a micrometer gauge, showed that 63 μm of filled resin was deposited on each side of the web (assuming that both sides were coated identically).

The web thus prepared passed between two abrasive rolls rotating in the opposite direction to its movement. The coated web, having a shiny surface at entry, left with a matt finish and a brighter red colour than originally.

The web thus stripped on the surface was then reduced by a potassium borohydride solution. The aqueous reduction bath contained, in solution: 0.5% of sodium hydroxide, 1% of carboxymethylcellulose, 5% of potassium borohydride and 1% of an aqueous solution containing 1% of a surfactant. The bath was continuously stirred by air being bubbled in.

The web was quickly immersed in the reduction bath (contact for about 5 s) and then the reactant entrained by the web in the form of a thin film reacted in air for about one minute.

The web was then continuously rinsed by passing it through an exhausted bath and then subjected to water spraying on both sides, and finally the liquid water on the surface was removed by running the web past compressed-air blowing nozzles. The surface resistivity between point electrodes was then between 15 and 30 Ω for a distance of 20 cm.

The web thus prepared then passed through a commercial chemical copperplating bath in which return rolls increase the residence time in the bath. After 15 minutes' contact, the copper deposit was about 1 μm on each side of the web. This deposit could then have been increased by passing through a copper sulphate plating bath.

Preparation 3:

This preparation illustrates the formation of a circuitry on each side of the metallized dielectric obtained in the previous preparation.

Specimens cut from the web, copperplated on both sides in Preparation 2, were then able to be made in the form of a circuit using the “pattern plating” technology, which includes:

the calendering of a dry “photoresist” film on each side;

its irradiation through masks brought into contact with the substrate;

the development using a mild basic solution leaving only the negative part of the mask unchanged;

and finally the electrolytic reinforcement of the exposed copperplated parts.

The electrolytic reinforcement was carried out in an aqueous bath containing 75 g/l of copper sulphate (CuSO₄.5H₂O) and 2 mol/litre of sulphuric acid, together with a commercial brightener. The anodes of the device consisted of pure copper plates enclosed in bags consisting of fine cloth made of synthetic yarns. The electrolysis current was set at 3 A/dm². After about ten minutes, the electrolytic reinforcement was stopped and the treated specimen was rinsed.

The rest of the photoresist film was then dissolved using a strongly basic solution, revealing the desired circuit as an additional thickness with respect to the thin copperplated base. The difference in thickness between these two regions was about 9 μm on both sides.

Lastly, the double-sided circuit was immersed in a gently stirred aqueous bath containing 10% ferric chloride and, after two minutes, it was rinsed with water. Only the desired circuit then appeared, with a highly matt finish, on a base free of copper. Running the product rapidly through an acid bath containing 1% sulphuric acid restored the brightness of the copper circuits, which were then rinsed and dried.

### EXAMPLE

The Cu₂O-filled dielectric resin prepared in Preparation 2 was used, together with the double-sided circuit produced in Preparation 3. The resin was spread over one side of the circuit using a Meyer doctor blade and dried by passing it into a fan oven for 15 minutes at 190° C. The same operation was carried out on the other side and then the circuit was abraded by passing it between two abrasive rolls, as in Preparation 2. The average increase in thickness of the double-sided circuit was 112 μm, i.e. 56 μm per side assuming an identical deposit. The planarity of the circuit was satisfactory.

The drilling operations were then carried out, on each side, using a CO₂ laser according to a preestablished drawing. This drilling was carried out directly without any particular preparation of the specimen. Examination in a binocular microscope showed that the drillholes were roughly circular with a diameter in the upper part of about 80 μm.

A reduction operation was then carried out, followed by chemical copperplating as indicated in Preparation 2.

Finally, the operations described in Preparation 3 were carried out so as to obtain thereafter a multilayer circuit of four levels, the layers 1 and 2 of which, on the one hand, and levels 3 and 4 of which, on the other hand, were interconnected.

The procedure exemplified above (the subject of this example) could then be repeated for the purpose of adding two new circuit levels.

1. Process for producing a circuitry comprising conducting tracks, pads and microvias, on the upper surface of a dielectric consisting of a polymer matrix, of a compound capable of inducing subsequent metallization and, where appropriate, of one or more other, non-conducting and inert, fillers, the said dielectric covering a circuitry level or a metallized layer, by implementing the steps consisting in:
A) drilling right through the said dielectric without drilling the subjacent metallized layer or the subjacent circuitry level so as to form one or more microvias at the desired locations;
B) forming, by metallization, metal tracks, pads and microvias on the surface of the dielectric and of the microvias with the use of selective protection by deposition of a protective layer:

2. Process according to claim 1, characterized in that the compound capable of inducing subsequent metallization consists of particles of a metal oxide chosen from Cu, Co, Cr, Cd, Ni, Pb and Sb oxides and mixtures thereof.

3. Process according to claim 1, characterized in that the laser drilling is carried out in step A) by means of a laser.

4. Process according to claim 1, characterized in that the metallization is carried out on a sublayer capable of being metallized, which was formed previously on the surface of the microvias, and on the surface of the dielectric or of parts of the surface of the dielectric.

5. Process according to claim 1, characterized in that the compound capable of inducing subsequent metallization consists of particles of a metal oxide chosen from Cu, Co, Cr, Cd, Ni, Pb and Sb oxides and mixtures thereof, and in that step B) comprises the steps consisting in:
B1) forming a sublayer capable of being metallized on the surface of the microvias, and on the surface of the dielectric or of part of the surface of the dielectric, by subjecting all or part of the dielectric to the reducing action of a suitable reducing agent until a metal sublayer covering, in particular, the microvias is obtained, by reduction of the metal oxide particles on the exposed surface of the dielectric, the surface resistivity of which is between 0.01 and 10¹⁰ Ω/;
B2) producing a circuitry comprising tracks, pads and microvias by implementing a sequence of treatment steps comprising, in a suitable order, step (i) of electrochemical (electroless) and/or electrolytic metallization and step (ii) of selective protection by deposition of a protective layer.

6. Process according to claim 5, characterized in that step B2) includes an etching step (iii).

7. Process according to claim 5, characterized in that
in step B1) the sublayer is formed over the entire surface of the dielectric and of the microvias, this sublayer being, where appropriate, reinforced by metallization over all of the dielectric and of the microvias;
step B2) involves the implementation, in order, of the following steps B2a) to B2d):
B2a) coating certain parts of the surface of the dielectric resulting from step B1) with a protective layer, the parts that are not covered corresponding to the regions intended to form the desired interconnect circuitry; B2b) reinforcing the said parts not covered in B2a) with a complementary metal deposit applied electrochemically (electrolessly) and/or electrolytically;
B2c) exposing the upper surface of the dielectric by removing the protective layer deposited in step B2a);
B2d) subjecting the metal deposited on the dielectric to differential etching until complete removal, at those parts of the dielectric which were exposed in step B2c), of the sublayer B1).

8. Process according to claim 7, characterized in that step B2a) comprises the steps consisting in:
B2aα) depositing a layer of photosensitive resin over the entire surface of the dielectric, after treatment with the reducing agent;
B2aβ) forming an image on the photosensitive layer by irradiation;
B2aχ) removing the dissolvable part of the said layer of photosensitive resin.

9. Process according to claim 5, characterized in that the reducing agent for forming the sublayer in step Bl) is an alkaline borohydride, the reduction being carried out by bringing the said dielectric into contact with an aqueous solution of the said borohydride until a continuous copper layer having a surface resistivity of between 0.01 and 10¹⁰ Ω/is obtained.

10. Process according to claim 2, characterized in that the dielectric consists of:
from 10 to 90%, preferably from 25 to 90%, by weight of metal oxide;
from 0 to 50% by weight of inert non-conducting filler(s); and
from 10 to 90%, preferably from 10 to 75%, by weight of polymer resin;
and in that in step B1) the reduction is continued until a surface resistivity of between 0.01 and 10³ Ω/is obtained, the metallization in step B2) being carried out electrolytically.

11. Process according to claim 5, characterized in that the metal oxide particles are cuprous oxide particles and in that, in step B1) a metallic copper sublayer is deposited on the exposed surface of the said dielectric.

12. Process according to claim 5, characterized in that the metallization in step B2) consists of a metallic copper deposit.

13. Process according to claim 1, characterized in that the compound capable of inducing subsequent metallization consists of particles of a metal oxide chosen from Cu, Co, Cr, Cd, Ni, Pb and Sb oxides and mixtures thereof and in that step B) comprises the steps consisting in:
B1) forming a sublayer capable of being metallized on the surface of the microvias, and on the surface of the dielectric or of part of the surface of the dielectric, by subjecting all or part of the dielectric to the action of a solution of a noble metal salt capable of being reduced by the oxide particles;
B2) producing a circuitry comprising tracks, pads and microvias by carrying out a sequence of treatment steps comprising, in a suitable order, step (i) of electrochemical (electroless) and/or electrolytic metallization and step (ii) of selective protection by deposition of a protective layer.

14. Process according to claim 2, characterized in that step B) comprises the following steps:
b1) forming, on the dielectric and on the microvias, a layer of photosensitive resin intended to form the selective protection, this layer not containing a compound capable of inducing subsequent metallization;
c1) irradiating and developing the layer of photosensitive resin so as to selectively expose the microvias and certain parts of the dielectric;
d1) forming a sublayer capable of being metallized
either by coming into contact with a solution of a noble metal salt capable of being reduced by the metal oxide particles,
or by coming into contact with a reducing agent capable of reducing the metal oxide particles;
e1) electrochemical and/or electrolytic metallization so as to deposit a metal layer on the parts exposed during step c1).

15. Process according to claim 2, characterized in that step B) comprises the following steps:
b2) forming a sublayer capable of being metallized on the surface of the dielectric and of the microvias:
either by coming into contact with a solution of a noble metal salt capable of being reduced by the metal oxide particles,
or by coming into contact with a reducing agent capable of reducing the metal oxide particles;
c2) electrochemical and/or electrolytic metallization so as to deposit a metal layer on the dielectric and on the microvias;
d2) forming, on the metallized surface, a layer of photosensitive resin intended to form the selective protection;
e2) irradiating and developing the layer of photosensitive resin so as to selectively expose certain parts of the metal layer;
f2) removing the metal layer from the parts exposed during step e2);
g2) removing the layer of photosensitive resin.

16. Process according to claim 1, characterized in that the dielectric surface is obtained from a laminated article comprising a layer of metal and a layer of the said dielectric, consisting of a polymer matrix, of a compound capable of inducing subsequent metallization and, where appropriate, of one or more other, non-conducting and inert, fillers.

17. Use of the process according to any one of claims 1 to 16 for the production of printed circuits and of multilayer modules having a high integration density.

18. Circuitry comprising tracks, pads and microvias, capable of being obtained by implementing a process according to any one of claims 1 to 16.

19. Printed circuit comprising at least one circuitry according to claim 18.

20. Multilayer module comprising at least one circuitry according to claim 18.
